(19) United States
(12) Patent Application Publication
(10) Pub. No.: US 2010/0169546 A1
(43) Pub. Date: Jul. 1, 2010

(54) FLASH MEMORY ACCESS CIRCUIT

(75) Inventors: Victor Martinus Gerardus Van Acht, Eindhoven (NL); Nicolaas Lambert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,675

(22) PCT Filed: Aug. 13, 2007
(86) PCT No.: PCT/IB07/53201

§ 371 Date: Feb. 17, 2009

(30) Foreign Application Priority Data
Aug. 15, 2006 (EP) 06118935.3

(51) Int. Cl. G06F 12/00; G06F 12/02; G06F 13/28; G06F 13/24

(52) U.S. Cl. 711/103; 710/22; 710/260; 711/E12.001; 711/E12.008

(57) ABSTRACT

A system comprises an instruction processor (10), a flash memory device (14a), a flash control circuit (14) and a working memory (16). Instructions of an interrupt program are kept stored in the flash memory device (14a). When the instruction processor (10) receives an interrupt signal, the instruction processor (10) executes loading instructions, to cause the flash control circuit (14) to load said instructions of the interrupt program from the flash memory device (14a) into the working memory (16). The instructions of the interrupt program are subsequently executed with the instruction processor (10) from the working memory (16). Preferably it is tested whether a copy of said instructions of the interrupt program is stored in the working memory (16) at the time of the interrupt. If the copy is found stored, execution of said instructions from the copy is started before completing execution of of access instructions that were in progress at the time of the interrupt. If the copy is not found stored, execution of the access instructions is first completed and subsequently the instruction processor (10) executes the loading instructions, followed by execution of the instructions of the copy of interrupt program from the working memory (16).

### FIELD OF THE INVENTION

The invention relates to a flash memory access circuit, and to a method of operating a flash memory access circuit.

### BACKGROUND OF THE INVENTION

Flash memories are well known per se. Flash memory provides for high-density non-volatile memory. NAND flash in particular provides for high circuit density. However, this comes at the expense of long access latency and a relatively slow access speed compared to state of the art RAM memory. Control of flash memory with a main processor of a processing system can therefore significantly slow down processing.

U.S. Pat. No. 6,874,044 discloses a flash card reader that controls transfer of data between a flash memory and a USB bus as well as some local intelligence. For transfer purposes the flash card reader contains a serial engine that interfaces to the USB bus, a flash card controller coupled to the flash memory and a RAM buffer for buffering data between the flash card controller and the serial interface. The flash card also contains a CPU and a ROM instruction memory. The CPU is an instruction processor that executes instructions from the ROM. This makes it possible to execute programs locally in the flash card reader to enhance its functionality.

U.S. Pat. No. 6,874,044 uses two busses between the serial engine and the flash card controller in order to avoid that bus conflicts between program related data transfers (including instruction loading) by the CPU and flash memory reduce speed. Both the CPU and the serial interface are capable of transmitting access requests to the flash card controller. The flash card controller handles these requests autonomously while the CPU and the serial interface can proceed with other actions.

US2003156473 discloses a memory system having a controller and a non-volatile memory storing firmware for start up and for normal operation of the system, the controller comprising a volatile memory and a processor, wherein the controller is arranged to operate during initialization or configuration of the system so that the startup firmware stored in the non-volatile memory is loaded into the volatile memory under hardware control by the controller and with the processor halted, the startup firmware in the volatile memory being subsequently executed by the processor.

U.S. Pat. No. 5,881,295 discloses a data processor which controls interrupts during programming and erasing of on-chip erasable and programmable non-volatile flash program memory. In general, when an interrupt or address error occurs, the processing by a central processing unit is branched to an interrupt handling routine or exception handling routine. A vector address showing the head address of an interrupt handling routine or exception handling routine is used to branch the processing by the central processing unit to the interrupt handling routine or exception handling routine. However, if an interrupt occurs or exception handling occurs when a flash memory is used as a program memory and erasing or programming is executed for the flash memory in the user program mode or boot mode, a central processing unit cannot obtain a desired vector address stored in the vector address storage area of the flash memory. Therefore, vector address data for interrupt handling or exception handling to be processed when an interrupt request or exception handling request to the central processing unit occurs while the data in the program memory is erased or programmed is previously stored in a predetermined area of a memory other than the program memory.

### SUMMARY OF THE INVENTION

Among others, it is an object of the invention to provide for a simple flash memory access circuit in which less overhead is needed to provide storage for programs for the instruction processor. The invention is defined by the independent claims. The dependent claims define advantageous embodiments.

According to one aspect a flash memory access circuit is provided. In this circuit the execution of instructions by instruction processor is used to control a flash control circuit that accesses a flash memory device. This is combined with use of the flash memory to provide the instruction processor with program instructions, comprising at least the instructions of an interrupt program for handling interrupts signaled to the instruction processor. In an embodiment the interrupts comprise interrupts generated by a communication circuit of the flash memory access circuit, such as an USB-slave circuit.

The instruction processor handles an interrupt by executing the instructions of the interrupt program from a working memory, using a copy of the instructions of the interrupt program that has been loaded from the flash memory into the working memory. The instruction processor may address the working memory directly, or a memory management unit may be used to map processor-issued addresses of memory locations in the flash memory to locations in the working memory where a copy of content of the flash memory is stored. When an interrupt is generated and the instructions for handling the interrupt are not in the working memory, the instruction processor handles the interrupt by first executing loading instructions to load the instructions of the interrupt program from the flash memory.

Thus, the need for instruction memory space for storing the interrupt program is avoided and no fixed space need be reserved in advance in the working memory for the interrupt program.

In a typical embodiment interrupt handling involves automatically disabling other interrupts (at least interrupts of a same and lower priority level) and execution of instructions of the interrupt handling program while the other interrupts remain disabled, followed by re-enabling the interrupts. In a further embodiment the instructions of the interrupt program in the copy that is loaded from the flash memory device comprise instructions that will be executed before said re-enabling.

In an embodiment it is tested whether the copy of the instructions of the interrupt program has already been stored in the working memory before reception of the interrupt. Testing may be performed by the instruction processor itself, or for example by the memory management unit. In a further embodiment the sequence in which the instruction processor executes the instructions of the interrupt program and instructions for completing previously started access requests depends on whether the copy is found to be previously stored. If so, the instruction processor executes the instructions of the interrupt program first, but if not, the instruction processor delays loading of the copy and subsequent execution of the copy until after execution of instructions to handle of a previously started access request has been completed. In this way a maximum speed for handling the interrupt can be achieved, without the overhead of having to restart handling of previous access requests, or even losing data of such requests.

These embodiments are especially advantageous for NAND flash access, because they mitigate the effects of its considerable access latency.

According to another aspect, the instruction processor defines a queue of access requests to the flash memory device. In an embodiment the copy of the instructions of the interrupt program are loaded by placing a request to do so in the queue, after previous requests and using the instruction processor to handle the previous requests in the queue before handling the request to load the copy of the instructions of the interrupt program and handling the interrupt.

In an embodiment the instruction processor executes instructions to cause handling of requests in the queue in a pipelined fashion. “Pipelining”, as used herein, assumes that handling of an access request comprises successive stages, wherein different operations are applied to the access data. Operation in pipelined fashion means that different stages of handling different requests are executed in parallel with each other. Examples of different stages include for example stages for erasing a block of memory cells in the flash memory, programming a block of memory cells, reading a block of memory cells, transferring data between flash memory chip and flash controller, transferring data between flash controller and working memory, encoding a data block in an error correcting code (ECC), decoding according the ECC (i.e. error correction), encryption and decryption. Programming and reading may be performed in parallel for different banks of flash memory, but as far as this happens for data of a single request this is not called pipelined execution of different requests.

The different stages of handling access requests may be performed by different circuit parts of the flash control circuit, these circuit parts receiving control signals from the processor to start each stage from the instruction processor, under control of instructions executed by the instruction processor. Thus, the instruction processor suffices to control when the different pipeline stages are executed.

In an embodiment, encryption and encoding in the ECC for a request are performed sequentially as one stage, pipelined with a stage that involves programming for another request. In this case a pair of memories may be provided of which one is used to perform encryption and encoding for one request while the other is used to perform programming for another request, the roles of the memories being exchanged for alternate requests. It has been found that the speed of programming is such that maximum speed is achieved even if encryption and encoding are not mutually pipelined.

In an embodiment it is avoided to mix pipelined execution of flash read requests and flash programming requests in the queue. Before starting execution of a first stage of one type of request (reading or programming), all stages of execution of stages of previous requests of a different type (programming or reading) are first completed. This considerably simplifies flash memory access.

These and other objects and advantageous aspects will become apparent from a description of exemplary embodiments using the following Figures.

### BRIEF DESCRIPTION OF THE DRAWINGS

FIG. 1 shows a flash memory system;

FIG. 2 shows a flow chart of interrupt handling;

FIG. 3 shows a flash memory system; and

FIG. 4 shows a NAND flash control circuit.

### DETAILED DESCRIPTION OF EMBODIMENTS

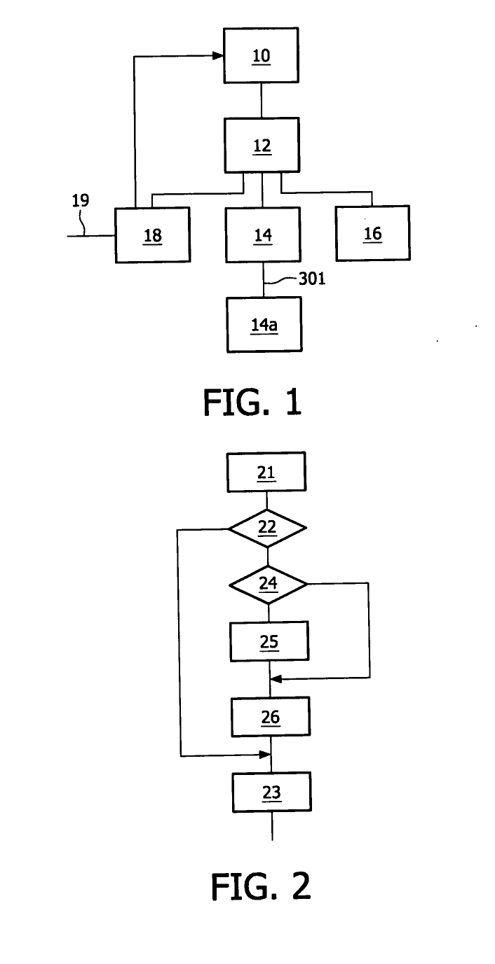

FIG. 1 shows an embodiment of a flash memory system, comprising an instruction processor 10, a memory management interface 12, a NAND flash control circuit 14, a NAND flash memory 14a, a local memory circuit 16 and a communication interface 18. Instruction processor 10 is coupled to local memory circuit 16 and a communication interface 18 via memory management interface 12. Furthermore, memory management interface 12 is coupled to NAND flash memory 14a via NAND flash control circuit 14 and a flash memory port 301. Communication interface 18 has a terminal 19 for receiving and/or transmitting information, and an output coupled to an interrupt input of instruction processor 10. Communication interface 18 may support for example communication according to the known USB (Universal Serial Bus) over terminal 19. Local memory circuit 16 may be a volatile memory circuit such as an SRAM or a DRAM. The components of the system may be integrated in an integrated circuit. In an embodiment the components except for NAND flash memory 14a are integrated together in an integrated circuit, NAND flash memory 14a being integrated in one or more separate integrated circuits. In this embodiment flash memory port 301 comprises terminals of the integrated circuit wherein the components except for NAND flash memory 14a are integrated.

In operation instruction processor 10 executes a program of instructions that are provided by NAND flash memory 14a. When instruction processor 10 has to execute such instructions, it causes memory management interface 12 to load the program or a program section containing a plurality of instructions from NAND flash memory 14a into local memory circuit 16. Subsequently, when instruction processor 10 issues addresses of instructions memory management interface 12 maps these addresses to local memory circuit 16 and retrieves the instructions from local memory circuit 16 for execution by instruction processor 10. Memory management interface 12 may be a complete memory management unit, which selects working memory locations for storing copies etc., or management may be performed by instruction processor 10. Also all functions of memory management interface 12 may be implemented with instruction processor 10 (mapping being implemented by using a base address pointer for example). Together memory management interface 12 and instruction processor 10, or instruction processor by itself, when it performs memory management, will also be called processor herein.

The instructions may include instructions for reading and/or writing data from or to NAND flash memory 14a. Reading and/or writing of NAND flash memory 14a typically is performed on a per block basis, each block containing data for a plurality of addresses, such as a page or section. Also, reading and/or writing in NAND flash memory 14a typically involves applying a plurality of successive actions to a block, which may be performed under control of different instructions for instruction processor 10. During program execution signals may be generated by an external device (not shown), such as a PC (Personal Computer) connected to terminal 19, to cause execution of commands. When communication interface 18 detects such a signal, it generates an interrupt to instruction processor 10, for causing instruction processor to interrupt normal program execution and to start executing an interrupt program. The instructions of the interrupt program are stored in NAND flash memory 14a and copied to local memory circuit 16 for execution of the interrupt program.

FIG. 2 shows a flow-chart of operation during handling of an interrupt. In a first step 21 processing circuit 10 receives the interrupt. An interrupt program is defined for the interrupt. In an embodiment, a plurality of different types of interrupts is possible, each associated with a different interrupt program (e.g. by means of an interrupt vector table, or jump table). In a second step 22 it is tested whether the interrupt program for the interrupt has previously been copied to local memory circuit 16 and is still stored in local memory circuit. This step may be performed for example by memory management interface in response to a NAND flash memory address of the interrupt program from instruction processor 10. If a copy of the interrupt program is stored in local memory circuit 16, a third step 23 is executed wherein instruction processor 10 executes the interrupt program using the instructions from local memory circuit 16. After completion of the interrupt program instruction processor 10 is made to resume normal program execution from where it left off following the interrupt.

If second step 22 detects that no copy is stored, a fourth step 24 is executed, wherein it is tested whether instruction processor 10 was executing a NAND flash access operation at the time of the interrupt. If, so a fifth step 25 is executed, executing instructions to complete a NAND flash access operation of the interrupted program. Said completing in fifth step 25 at least includes finishing of successive writing of data elements for a programming action for a programming unit of the NAND flash memory 14a. As is known, programming of NAND flash has to be performed on a per unit basis without intervening reading or writing of other units. Once another unit is accessed the previous unit can only be reprogrammed as a whole. By completing the programming action it is made unnecessary to repeat the whole programming action after loading of the interrupt program. After said completing in fifth step 25 has been executed, a sixth step 26 is executed, of loading the interrupt program from NAND flash memory 14a into local memory circuit 16. Subsequently, third step 23 is executed.

If it is detected in fourth step 24 that instruction processor 10 was not executing a NAND flash access operation at the time of the interrupt, sixth step 26 is executed immediately after fourth step 24, without prior execution of instructions from the interrupted program.

In this way, the interrupt is handled immediately if a copy of the interrupt program is available in local memory circuit 16, but when the interrupt program has to be loaded from NAND flash memory 14a, NAND flash access operations may be finished first before executing the interrupt program. Thus, no special non-volatile memory is needed for storing interrupt programs and a high-speed response to the interrupt is available when a copy of the interrupt program is stored.

Typically, the size of the address space of local memory circuit 16 is much smaller than that of NAND flash memory 14a. Not all instructions of all programs that are stored in NAND flash memory 14a can be stored simultaneously in local memory circuit 16. Therefore, instructions that are loaded into local memory circuit 16 will typically be written at memory locations where other instructions were stored previously, so that these other instructions will have to be reloaded when they are needed again. In an embodiment only part of an interrupt program may be loaded. In this case interrupted flash memory access operations are preferably completed before execution of the interrupt program, even though a start of the interrupt program is stored in local memory circuit 16. But alternatively, the stored part of the interrupt program may be executed immediately upon the interrupt, the interrupted flash memory access operations being completed subsequently if and before an unstored part of the interrupt program is loaded.

Various solutions may be used to ensure completion of the access instructions in fifth step 25. In one embodiment the programs of instruction processor 10 is configured to store state information indicating the progress of a flash memory access operation or plural flash memory access operations and the location of data involved with such operations. In this embodiment, when the interrupt program is not in local memory circuit 16 it is tested whether the stored state information indicates that an access operation is in progress of a type that should be completed. If so the state information is used to complete the access operation in fifth step 25 and the state information is updated. It may be noted that each program for instruction processor 10 may define a set of state information that includes the state information about flash memory access. Typically, all other parts of the set of state information are saved at the interrupt and restored to their saved value after handling of the interrupt. The state information about the access operation is exceptional in this respect, in that it may be updated after the interrupt and before resumption of the interrupted program.

In another embodiment completion of the access instructions in fifth step 25 may be enforced by storing information (in instruction processor 10 or local memory circuit 16 for example) that indicates access instructions, or by storing such access instructions at memory locations within a predetermined address range. In this case a program counter value at the time of interruption may be compared with the stored information or with the predetermined address range and if it is detected that the instruction at the time of the interrupt is involved with access, execution of the access instructions may be continued. At the end of a series of instructions involved with access, instructions may be included in the program to detect whether interrupt handling is pending, so as to initiate execution sixth step 26.

In another embodiment a program of instruction processor 10 may be configured to cause instruction processor 10 to maintain a pipeline of NAND flash access operations. NAND flash access operations may be broken into successive stages, such as encryption decryption, error correcting coding/decoding, page addressing, erasing, transfer of data between the NAND flash control circuit 14 and NAND flash memory 14a, programming and reading. The pipeline may be implemented for example by storing a list of successive access operations and a set of pointers, for respective ones of the stages, each indicating the access operation to which the corresponding stage has to be applied next. Alternatively, each request in the list may be combined with a stage indicator to indicate the next stage that has to be applied to the request. Alternatively, a plurality of lists may be used, each for a different one of the stages, and each indicating the access operations to which the stage must be applied successively (an access operation being added to the list for the next stage once a preceding stage has been applied to it).

In this embodiment instruction processor executes a pipeline handling program in addition to other programs. The other programs issue NAND flash access requests, which are inserted into the pipeline and the pipeline handling program controls application of the stages to the NAND flash access requests in the pipeline. When the pipeline handling program has completed handling the access request it signals this to the other programs, so that these are enabled to continue with a part of execution that depends on the access.

In this embodiment, when, upon an interrupt, the interrupt program is not present in local memory circuit 16, the access operation for loading the interrupt program from NAND flash memory 14a in response to an interrupt is placed in the pipeline, following previously started access operations. In this case, execution of instructions of the pipeline handling program by instruction processor is not disrupted for the execution of the interrupt program if the interrupt program is not in local memory circuit 16. Instead, pipeline handling instruction execution continues until the interrupt program has been loaded, after which the interrupt program is executed. However, after the interrupt, instruction processor 10 suspends the execution of programs other than the pipeline handling program until the interrupt program has been executed.

In this embodiment additional circuits may be provided to perform various stages of pipeline handling in parallel. Thus, instruction processor 10 may be arranged to execute other programs while execution of a stage is performed by such an additional circuit. Alternatively instruction processor 10 may execute another stage while execution of a stage is performed by such an additional circuit.

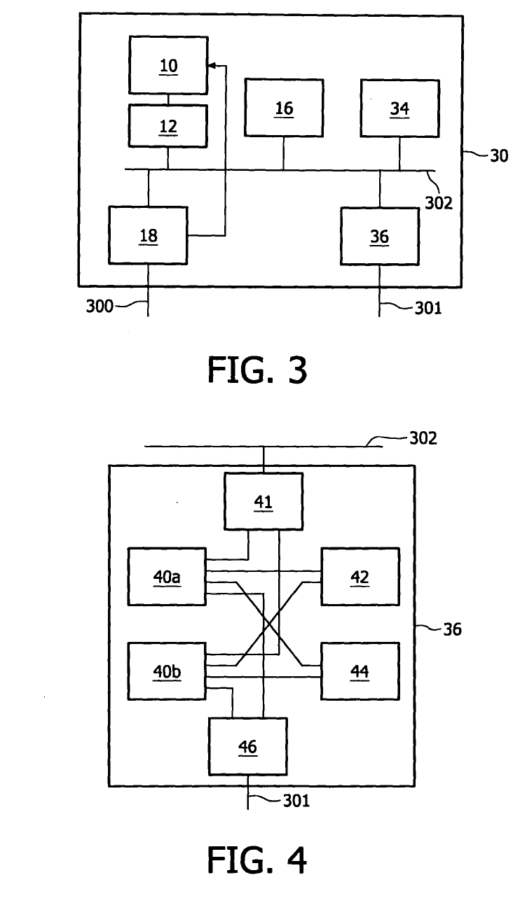

FIG. 3 shows an embodiment of a flash memory system comprising a processing circuit 30 and a NAND flash memory circuit 14a. Processing circuit 30 has a communication port 300, a flash memory port 301 and a local bus 302. NAND flash memory circuit 14a is coupled to flash memory port 301. Processing circuit 30 comprises an instruction processor 10, a local memory circuit 16, a communication port interface 18, a DMA (Direct Memory Access) circuit 34 and a NAND flash memory control circuit 36, all coupled to local bus 302. Instruction processor 10 is coupled to local bus 302 via memory management interface 12. Communication port interface 18 is coupled between communication port 300 and local bus 302. NAND flash memory control circuit 36 is coupled between flash memory port 301 and local bus 302.

In an embodiment the various components of FIG. 3 are integrated together in a single integrated circuit device, for use as a communication port-NAND flash interface device.

In operation memory management interface 12 loads program instructions from local memory circuit 16 via local bus 302, and instruction processor 10 executes these instructions. Program parts containing the instructions are loaded into local memory circuit 16 from NAND flash memory 14a for this purpose. Typically, instruction processor 10 initiates loading by issuing a request for a program part or by addressing an initial instruction of such a program part. Memory management interface 12 thereupon sends commands to NAND flash memory control circuit 36 and to DMA circuit 34.

In response NAND flash memory control circuit 36 retrieves the program part from NAND flash memory 14a and decodes it. DMA circuit 34 controls transfer of the program part from NAND flash memory control circuit 36 to local memory circuit 16. In an embodiment, processor 10 controls the NAND flash memory control circuit 36 and DMA controller 34, after receiving a signal to do so from memory management interface 12. This means that the control of the NAND flash memory control circuit 36 and DMA circuit 34 may be implemented in software.

Communication port interface 18 receives commands from a host processor (not shown) that is coupled to communication port 300. For this purpose communication port 300 and communication port interface 18 may support a known USB interface for example. Upon receiving certain types of command, communication port interface 18 sends interrupt signals to instruction processor 10. In response to the interrupt signals instruction processor 10 switches from execution of a current program part to execution of an interrupt program that comprises instructions for handling the interruption. If the instructions of the interrupt routing are stored in local memory circuit 16, instruction processor 10 immediately executes the interrupt routine once it grants the interrupt. However, if the instructions of the interrupt routing are not stored in local memory circuit 16, instruction processor 10 first issues a request to load the instruction of the interrupt routine from NAND flash memory 14a into local memory circuit 16. The request is added to the pipeline and processing of the requests in the pipeline continues until the request for loading the interrupt program has been handled. The interrupt program is executed once it has been loaded.

Handling of requests to access NAND flash memory 14a is performed in a plurality of stages. In one embodiment, the stages for reading include data transfer from NAND flash memory 14a, ECC (Error Correcting Code) decoding and decryption. In another embodiment, the stages for programming include encryption, ECC coding and data transfer to NAND flash memory 14a.

FIG. 4 shows an embodiment of NAND flash memory control circuit 34, including a first and second buffer memory 40a,b, a bus interface 41, an ECC processing circuit 42, a decryption/encryption processing circuit 44, a local DMA circuit 46 and a control circuit 48. Bus interface 41 is configured to transfer data to and from buffer memories 40a,b under control of the DMA circuit 36 of FIG. 3. ECC processing circuit 42 and decryption/encryption processing circuit 44 are configured to process data in a selectable one of buffer memories 40a,b, while leaving free access to the other buffer memory 40a,b. Local DMA circuit 46 is configured to transfer data between a selectable one of buffer memories 40a,b and NAND flash memory 14a (not shown), while leaving free access to the other buffer memory 40a,b.

In operation NAND flash memory control circuit 34 performs data transfer to and from NAND flash memory 14a, ECC (Error Correcting Code) decoding and encoding and decryption/encryption. In an embodiment using the circuit of FIG. 4 pipeline access operations include the further stages of transfer to and from buffer memories 40a,b.

A programming operation for a data block involves the stages of (1) DMA transfer of the data block to one of the buffer memories 40a,b, (2) encryption (3) ECC encoding, (4) programming of NAND flash memory 14a using the data from the buffer memory Programming the NAND flash memory 14a may include the following steps: (1) writing a predefined Program command byte to the NAND flash memory 14a, followed by the address; (2) transferring the data to the NAND flash memory 14a via the local DMA controller 46; (3) writing the ProgramExecute command byte to the NAND flash memory 14a; (4) waiting for the NAND flash memory 14a to complete the command; (5) writing the ReadStatus command byte to the NAND flash memory 14a and read back the status. Encryption and ECC encoding are performed by replacement of and/or addition to the data in one of the buffer memories. Different stages may be executed in parallel for different access requests, using different ones of buffer memories 40a,b.

Encryption and ECC encoding for a data block are performed on the same buffer memory 40a,b that stores the data block. Alternatively, buffer memories may be included between the stages, so that for encryption the data is read from one buffer memory and results are written to another buffer memory, and so on for ECC encoding. However, it has been found that buffer memory space can be saved by using one buffer memory for both Encryption and ECC encoding, because both can be executed in the time needed to transfer the data block to or from NAND flash memory 14a.

A read operation for a data block involves the stages of (1) sending a ReadPage command to the NAND flash memory 14a, followed by the address bytes; (2) waiting for the NAND flash memory 14a to retrieved the requested information and then (3) transferring a data block from NAND flash memory 14a to one of the buffer memories, (4) ECC decoding (i.e. error correction) (5) decryption and (6) DMA transfer of the data block from the buffer memory 40a,b to the bus. Decryption and ECC decoding are performed by replacement of and/or addition to the data in one of the buffer memories. Different stages may be executed in parallel for different access requests, using different ones of buffer memories 40a,b.

In an embodiment, pipelining is controlled by instruction processor 10. Instruction processor 10 maintains information that describes the state of requests in the pipeline. On the basis of this information instruction processor 10 sends signals to DMA circuit 36, ECC processing circuit 42, decryption/encryption processing circuit 44 and local DMA circuit 46 to trigger processing of data blocks by these units when a unit is free and it is the turn of a request in the pipeline to be processed by the unit. Instruction processor 10 determines when the data blocks have been processed (e.g. by polling or on interrupt basis) and updates the information that describes the state of requests in the pipeline.

In an embodiment only requests of one type (programming or reading) are pipelined at a time. When one or more requests of a first type are pipelined and a request of a second, different type is received, the stages of processing the one or more requests of the first type are first finished before processing of the request of the second type is started. This simplifies pipelining.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements, and/or by means of a suitably programmed processor. In the device claim enumerating several means, several of these means may be embodied by one and the same item of hardware. The mere fact that certain measures are recited in mutually different dependent claims does not indicate that a combination of these measures cannot be used to advantage.

1. A flash memory access circuit, comprising:
a flash interface port (301) for accessing a flash memory device (14a);
a working memory (16) coupled to said flash interface;
a flash control circuit (14); and
an instruction processor (10) coupled to said working memory (16) and the flash control circuit (14), the instruction processor (10) having an interrupt input, the instruction processor (10) being programmed to handle an interrupt signaled at the interrupt input by executing loading instructions to cause the flash control circuit to load a copy of instructions of an interrupt program from the flash memory (14a) via said flash interface for storage into the working memory (16) and subsequently to handle the interrupt by executing the instructions of the copy from the working memory (16).

2. A flash memory access circuit according to claim 1, wherein the instruction processor (10) is programmed to cause processing of a request to access the flash memory (14a) by executing a series of request handling instructions, and wherein the instruction processor (10) is comprised in a processor (10, 12) that is configured to test, in response to receiving the interrupt, whether the copy has been stored in the working memory (16) previous to the interrupt, and to execute the loading instructions after completing execution of said series of request handling instructions if the copy is not found stored, if the interrupt occurs after a start of execution of the series of request handling instructions, the instruction processor (10) being programmed to handle the interrupt by executing said instructions of the copy before or after completing execution of said series of request handling instructions, dependent on whether the copy is found previously stored or not respectively.

3. A flash memory access circuit according to claim 1, comprising the flash memory device (14a) coupled to said flash interface.

4. A flash memory access circuit according to claim 3, wherein the flash memory device (14a) is a NAND flash memory device.

5. A flash memory access circuit according to claim 1, comprising an external communication interface (19) and a communication circuit (18) coupled between the external communication interface (19) and the working memory (16), the communication circuit (18) being coupled to said interrupt input for generating the interrupt in response to reception of a request at the external communication interface (19).

6. A flash memory access circuit according to claim 1, wherein the instruction processor (10) is programmed to represent a queue of successively received requests to access the flash memory device (14a) and to execute a plurality of series of request handling instructions to cause processing of the successively access requests in a sequence in which the requests have been added to the queue.

7. A flash memory access circuit according to claim 6, wherein the instruction processor (10) is programmed to add a request to load said instructions of the interrupt program to an end of the queue at a time of receiving the interrupt signal, if the copy is not found in the working memory in response to the interrupt.

8. A flash memory access circuit according to claim 6, wherein the instruction processor (10) is programmed to cause the access requests in the queue to be processed in pipelined fashion.

9. A flash memory access circuit according to claim 8, wherein, when the access request is a request to program a data block in the flash memory device, processing of the access request comprising programming of the data block preceded by at least one of the actions of DMA transfer of the data block to the flash memory control circuit (14), encryption of the data block and encoding of the data block in an error correcting code, the instruction processor (10) being programmed to cause said action and programming of successive access requests to program data blocks to be executed in pipelined fashion.

10. A flash memory access circuit according to claim 8, wherein the flash control circuit (14) comprises an encryptor (42) and an encoder (44) for an error correcting code, the instruction processor (10) being programmed to cause the encryptor (42) and the encoder (44) to process the data block of a request in parallel with programming of a data block of a preceding access request.

11. A flash memory access circuit according to claim 10, wherein the flash control circuit (14) comprises a first and second local memory (40a,b), both the encryptor (42) and the encoder (44) being coupled to one of the first and second local memory (40a,b) to process a same data block successively while the flash control circuit (14) programs data into the flash memory device (14a) for another one of the first and second local memory (40a,b).

12. A flash memory access circuit according to claim 6, wherein the access requests each belong to one of a plurality of different types of request, including read requests and programming requests, and wherein the instruction processor (10) is programmed to detect, upon adding each added request to the queue, whether the added request is of a first one of the types different from a second one of the types of any previously added request in the queue, and if so, to complete processing of all queued requests of said a second one of the types, before causing processing of the added request to start.

13. A flash memory access circuit, comprising:
a flash interface port (301) for accessing a flash memory device (14a);
a working memory coupled to said flash interface (16);
a flash control circuit (14); and
an instruction processor (10) coupled to said working memory (16) and the flash control circuit (14), wherein the instruction processor is programmed to represent a queue of successively received requests to access the flash memory device (14a) and to execute a respective series of request handling instructions in response to each of the requests, the request handling instructions being for causing the flash control circuit (14a) to process respective stages of handling the successively access requests, instruction processor (10) being programmed to select a sequence of execution of the request handling instructions for different requests so that the flash control circuit (14) is made to operate in pipelined fashion in conformance with a sequence in which the requests have been added to the queue.

14. A flash memory access circuit according to claim 13, wherein the access requests each belong to one of a plurality of different types of request, including read requests and programming requests, and wherein the instruction processor is programmed to detect, upon adding each added request to the queue, whether the added request is of a first one of the types different from a second one of the types of any previously added request in the queue, and if so, to complete processing of all queued requests of said a second one of the types, before causing processing of the added request to start.

15. A flash memory access circuit according to claim 13, wherein, when the access request is a request to program a data block in the flash memory device (14a), processing of the access request comprising programming of the data block preceded by at least one of the actions of DMA transfer of the data block to a flash memory control circuit (14), encryption of the data block and encoding of the data block in an error correcting code, the instruction processor (10) being programmed to cause said action and programming of successive access requests to program data blocks to be executed in pipelined fashion.

16. A flash memory access circuit according to claim 13, wherein, when the access request is a request to read a data block in the flash memory device (14a), processing of the access request comprising programming of the data block followed by at least one of the actions of DMA transfer of the data block from the flash memory control circuit (14), decryption of the data block and decoding of the data block according to an error correcting code, the instruction processor (10) being programmed to cause said action and reading of successive access requests to program data blocks to be executed in pipelined fashion.

17. A method of operating a system that comprises an instruction processor (10), a flash memory device (14a), a flash control circuit (14) and a working memory (16), the method comprising:
keeping instructions of an interrupt program stored in the flash memory device (14a);
receiving an interrupt signal at the instruction processor (10);
using execution of loading instructions by the instruction processor (10) in response to the interrupt signal to cause the flash control circuit (14) to load said instructions of the interrupt program from the flash memory device (14a) into the working memory (16);
executing said instructions of the interrupt program with the instruction processor (10) from the working memory (16).

18. A method according to claim 17, wherein, at least when the instruction processor (10) is in progress of executing a series access instructions to process a request to access the flash memory device (14a) when the interrupt signal is received, the method comprises:
in response to the interrupt signal, testing whether a copy of said instructions of the interrupt program is stored in the working memory (16);
if the copy is found stored, starting execution of said instructions from the copy before completing execution of said series of access instructions;
if the copy is not found stored, completing execution of said series of access instructions and subsequently using the instruction processor (10) to execute the loading instructions, followed by execution of said instructions of the copy of interrupt program from the working memory (16) by the instruction processor (10).

19. A method according to claim 17, the method further comprising:
representing a queue of successively received access requests to the flash memory device (14a);
processing the access requests in a sequence in which the requests have been added to the queue.

20. A method according to claim 19, the method comprising adding an request to load the interrupt program to an end of the queue at a time of receiving the interrupt signal if the copy is not found.

21. A method according to claim 19, the method comprising processing the access requests in the queue in pipelined fashion.
